(19) United States
(12) Patent Application Publication
(10) Pub. No.: US 2020/0410567 A1
(43) Pub. Date: Dec. 31, 2020

(54) INFORMATION RECOMMENDATION DEVICE, METHOD, AND COMPUTER-READABLE STORAGE MEDIUM

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Baoyan MA, Beijing (CN); Shanshan LUO, Beijing (CN); Xiaoman WANG, Beijing (CN); Jiawen CHEN, Beijing (CN); Mianjun XU, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/644,013

(22) PCT Filed: Jul. 9, 2018
(86) PCT No.: PCT/CN2018/094994

§ 371 Date: Mar. 3, 2020

(30) Foreign Application Priority Data
Sep. 4, 2017 (CN) 201710786061.9

(51) Int. Cl. G06Q 30/06; G06F 16/9535; G06F 16/9538; H04L 29/08

(52) U.S. Cl. CPC G06Q 30/0631; H04L 67/26; G06F 16/9538; G06F 16/9535

(57) ABSTRACT

The present disclosure relates to an information recommendation device, method, and computer-readable storage medium, and relates to the technical field of computer. The information recommendation device includes: a receiver configured to receive a communication identifier of a contact of a recommended user; a processor configured to acquire a user identifier corresponding to the communication identifier of the contact, and acquire shopping information of the contact according to the user identifier; and a transmitter configured to recommend the shopping information of the contact to the recommended user.

### CROSS-REFERENCE TO RELATED APPLICATIONS

The present application is based on the application with a CN application number of 201710786061.9 and the filing date being Sep. 4, 2017 and claims its priority. The disclosure of this CN application as a whole is incorporated into the present application herein by reference.

### TECHNICAL FIELD

The present disclosure relates to the technical field of computer, and in particular, to an information recommendation device, method, and computer-readable storage medium.

### BACKGROUND

Currently, online shopping has become one of the main consumption ways of consumers. A user can obtain product information from a plurality of angles such as an event portal, a store portal, a product list, product details and the like. However, how a consumer selects a target product among a wide variety of products has become a problem.

The related art describes the characteristics of the product by displaying a product list, product details, and the like. The user needs to obtain the product information through searching or an event portal.

In addition, there are also algorithms for recommending a product for a user based on the user's historical shopping information. For example, a product matching preference or category of the user are recommended through inferring the user's preference from the user's own shopping information or classifying users.

### SUMMARY

The inventors find that although the related art shows the user the description of the product from various angles, the user still needs to obtain his target product through constant comparison.

The related recommendation method only carries out data mining based on information of the e-commerce platform itself. However, the information on the network is very complicated, so the existing recommendation method has a low probability of hitting the user's needs, and thus the recommendation efficiency is low.

In view of one or more of the above problems, embodiments of the present disclosure provide an information recommendation scheme capable of improving the recommendation efficiency.

According to a first aspect of some embodiments of the present disclosure, there is provided an information recommendation device, comprising: a receiver configured to receive a communication identifier of a contact of a recommended user; a processor configured to acquire a user identifier corresponding to the communication identifier of the contact, and acquire shopping information of the contact according to the user identifier; and a transmitter configured to transmit the shopping information of the contact to the recommended user.

In some embodiments, the receiver is further configured to receive the communication identifier of the contact of the recommended user acquired by a terminal from a communication application.

In some embodiments, the transmitter is further configured to transmit at least one of the following information to the recommended user: purchased item information with a rating higher than a preset level in the shopping information of the contact; or public shopping information of the contact.

In some embodiments, the shopping information comprises one or more of purchased item information, rating information, collection information, or browsing information.

In some embodiments, the processor is further configured to set the shopping information of a user public or private according to a request of the user.

In some embodiments, the processor is further configured to acquire shopping information of the recommended user; the transmitter is further configured to transmit the shopping information of the recommended user to the contact.

According to a second aspect of some embodiments of the present disclosure, there is provided an information recommendation device, comprising: a processor configured to acquire a communication identifier of a contact of a recommended user; a transmitter configured to transmit the communication identifier; a receiver configured to receive shopping information of the contact, wherein the shopping information of the contact is acquired via a user identifier of the contact corresponding to the communication identifier; and an output interface configured to output the shopping information of the contact to the recommended user.

In some embodiments, the output interface is further configured to output the shopping information of the contact and the communication identifier of the contact to the recommended user; the processor is further configured to, in response to an operation that the recommended user initiates communication to the contact, send the communication identifier of the contact to a communication application, so that the recommended user contacts with the contact through the communication application.

In some embodiments, the output interface is further configured to display the shopping information of the contact and other recommendation information in different manners.

According to a third aspect of some embodiments of the present disclosure, there is provided an information recommendation method, comprising: receiving a communication identifier of a contact of a recommended user; acquiring a user identifier corresponding to the communication identifier of the contact; acquiring shopping information of the contact according to the user identifier; and transmitting the shopping information of the contact to the recommended user.

In some embodiments, the communication identifier of the contact of the recommended user acquired by a terminal from a communication application is received.

In some embodiments, at least one of the following information is transmitted to the recommended user: purchased item information with a rating higher than a preset level in the shopping information of the contact; or public shopping information of the contact.

In some embodiments, the information recommendation method further comprises: setting the shopping information of a user public or private according to a request of the user.

In some embodiments, the information recommendation method further comprises: acquiring the shopping information of the recommended user; transmitting the shopping information of the recommended user to the contact.

According to a fourth aspect of some embodiments of the present disclosure, there is provided an information recommendation method, comprising: acquiring a communication identifier of a contact of a recommended user; transmitting the communication identifier; receiving shopping information of the contact, wherein the shopping information of the contact is acquired via a user identifier corresponding to the communication identifier; and outputting the shopping information of the contact to the recommended user.

In some embodiments, the shopping information of the contact and the communication identifier of the contact is outputted to the recommended user; the information recommendation method further comprising: in response to an operation that the recommended user initiates communication to the contact, sending the communication identifier of the contact to a communication application, so that the recommended user contacts with the contact through the communication application.

In some embodiments, the outputting the shopping information of the contact to the recommended user comprises: displaying the shopping information of the contact to the user, wherein the shopping information of the contact and other recommended information are displayed in different manners.

According to a fifth aspect of some embodiments of the present disclosure, there is provided an information recommendation device, comprising: a memory; and a processor coupled to the memory, the processor configured to perform any one of the foregoing information recommendation methods based on instructions stored in the memory.

According to a sixth aspect of some embodiments of the present disclosure, there is provided a computer-readable storage medium having stored thereon a computer program which, when executed by a processor, implements any one of the foregoing information recommendation methods.

Some embodiments of the above invention have the following advantages or beneficial effects: the information recommendation device provided by the embodiments of the present disclosure can recommend shopping information for the recommended user according to the shopping condition of the contact of the recommended user, so that the recommended content has higher credibility, which can improve the click rate and the order conversion rate of the user, and improve the recommendation efficiency.

Other features and advantages of the present disclosure will become clear through detailed descriptions of the illustrative embodiments of the present disclosure with reference to the following accompanying drawings.

### BRIEF DESCRIPTION OF THE DRAWINGS

In order to more clearly illustrate the embodiments or technical solutions in existing technologies of the present disclosure, a brief introduction will be given below for the drawings required to be used in the description of the embodiments or technical solutions in existing technologies. It is obvious that, the drawings illustrated as follows are merely some of the embodiments of the present disclosure. For an ordinary skilled in the art, he or she may also acquire other drawings according to such drawings without paying inventive efforts.

FIG. 1A shows a structural diagram of an information recommendation system according to some embodiments of the present disclosure.

FIG. 1B shows a structural diagram of a terminal according to some embodiments of the present disclosure.

FIG. 2 shows a structural diagram of an information recommendation platform according to some embodiments of the present disclosure.

FIG. 3 shows a structural diagram of an information recommendation application module according to some embodiments of the present disclosure.

FIGS. 4A to 4D show flow diagrams of information recommendation methods according to some embodiments of the present disclosure.

FIG. 5 shows a flow diagram of an information recommendation method according to further embodiments of the present disclosure.

FIG. 6 shows a flow diagram of an information recommendation method according to still further embodiments of the present disclosure.

FIG. 7 shows a flow diagram of an information recommendation method according to still further embodiments of the present disclosure.

FIG. 8 shows a structural diagram of an information recommendation device according to some embodiments of the present disclosure.

FIG. 9 shows a structural diagram of an information recommendation device according to further embodiments of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure instead of all of them. The following descriptions on at least one illustrative embodiment are actually illustrative, but shall not set any limitation on the present disclosure and its application or utilization. All other embodiments that are obtainable to those skilled in the art based on the embodiments of the present disclosure without any creative effort are included in the protection scope of the present disclosure.

Unless otherwise illustrated, respective arrangements, mathematic expressions and values of the components and steps illustrated in these embodiments do not limit the scope of the present disclosure.

Meanwhile, it shall be understood that in order to facilitate description, the respective parts shown in the drawings are not drawn in sizes according to actual proportional relations.

Techniques, methods and devices that have already been known to ordinary technicians in the art may not be discussed here in detail, but under suitable circumstances, the techniques, methods and devices shall be deemed as parts of the granted description.

In the embodiments shown and discussed here, any specific value shall be interpreted as only illustrative, instead of limitative. Hence, other embodiments of the illustrative embodiments may have different values.

It shall be noted that similar marks and letters represent similar items in the following figures, so once a certain item is defined in one figure, no further discussion on it is required in the following figures.

The inventors find that there are few social attributes in current e-commerce websites. The information that the user can refer to in the e-commerce websites is often information from strangers. Thus, the inventor contemplates that contacts of a user in a communication application having social and communication attributes may be introduced into recommendation, so that their shopping information is recommended to the user as a reference, so as to drain trust among the user and the contacts.

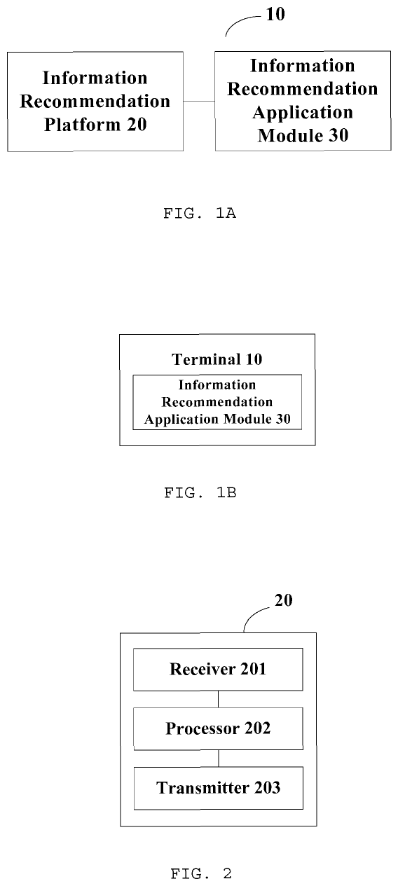

FIG. 1A shows an exemplary structural diagram of an information recommendation system according to some embodiments of the present disclosure. As shown in FIG. 1A, an information recommendation system 10 of the embodiments comprises two information recommendation devices, namely an information recommendation platform 20 and an information recommendation application module 30.

The information recommendation platform 20 may be located in a background system of an e-commerce website, and is capable of performing data interaction with the information recommendation application module 30.

The information recommendation application module 30 may be an e-commerce application or a sub-module of an e-commerce application. In some embodiments, the information recommendation application module 30 may be located in a terminal 10, as shown in FIG. 1B. The terminal 10 may be a mobile terminal such as a mobile phone, a tablet computer, a smart wearable device and the like; in addition, the information recommendation application module 30 may also be located in other devices capable of interacting with a user, such as a personal computer, etc., which are not described in detail herein.

Embodiments of the information recommendation platform of the present disclosure are described below with reference to FIG. 2.

FIG. 2 shows an exemplary structural diagram of an information recommendation platform according to some embodiments of the present disclosure. As shown in FIG. 2, the information recommendation platform 20 of the embodiments comprises a receiver 201, a processor 202, and a transmitter 203.

The receiver 201 and the transmitter 203 may be independent devices or may be presented in the form of a transceiver.

The receiver 201 is configured to receive communication identifier of a contact of a recommended user. In some embodiments, the receiver 201 may receive the communication identifier of the contact of the recommended user sent by the terminal. For example, the terminal may acquire the communication identifier from a communication application of the terminal, wherein the communication application may be a call application such as a telephone application, or may also be an instant chat software, or the like. In addition, the receiver 201 may also receive the communication identifier from a cloud or other servers, for example, from a cloud address book of the user or a background system of another application website.

The contact of the recommended user can be a friend of the recommended user, or can also be a person who exchanges contact information with the recommended user or a person who has the contact information left by the recommended user, and the like. The contact is either familiar with the recommended user or has similar characteristics to the recommended user, such as common hobbies, adjacent living areas, common friends, etc., and is therefore more trustworthy than unfamiliar users in the network. The communication identifier is identifier through which the contact can be contacted in a specific application or platform, and may be, for example, a phone number, a social network account, an email address, a personal homepage link, or the like.

The processor 202 is configured to acquire a user identifier corresponding to the communication identifier of the contact, and acquire shopping information of the contact according to the user identifier. Processor 202 may, for example, look up information from a database. For example, the database may store user identifiers of users of the e-commerce platform, as well as shopping information of the users. In addition, the database can also store basic information of the users, such as application accounts, telephone numbers, email address and other communication identifiers.

In some embodiments, the e-commerce platform may store a correspondence between the user identifier, the shopping information, and the communication identifier. Since the user identifier and the communication identifier are both unique, the processor 202 may search for the shopping information of the contact according to the correspondence. The shopping information may comprise one or more of purchased item information, rating information, collection information, browsing information, and the like. The processor 202 may obtain one or more types of the shopping information at a time as desired.

The transmitter 203 is configured to transmit the shopping information of the contact to the recommended user. In some embodiments, the transmitter 203 may be further configured to transmit the shopping information of the contact to a terminal of the recommended user, so that the recommended user acquires the recommended shopping information through the terminal.

Through the above-described embodiments, the information recommendation device provided by the present disclosure can recommend shopping information for the recommended user according to the shopping condition of the contact of the recommended user, so that the recommended content has higher credibility. Therefore the click rate and the order conversion rate are improved, thus the recommendation efficiency is improved.

The various components in the information recommendation platform provided by the present disclosure may also have further configurations to implement other functions.

In some embodiments, highly rated shopping information of a contact may be recommended to the user. The processor 202 may be further configured to acquire purchased item information of the contact and corresponding rating information according to the acquired user identifier, and determine the purchased item information whose rating is higher than a preset level; the transmitter 203 may be further configured to transmit the purchased item information whose rating is higher than a preset level of the items purchased by the contact to the recommended user.

For example, the rating is classified into good, medium and bad from high to low, and the preset level is medium. When contact A buys an mobile phone X and gives a rating of good to it, the processor 202 acquires these information, and the transmitter 203 transmits the information of the mobile phone X or transmits the information of the mobile phone X together with the comment content of the contact A on the mobile phone X to a terminal for display; if contact B purchases a mobile phone Y and gives a rating of bad, the processor 202 does not recommend the phone Y. Therefore, the recommended user can obtain products with an rating by the contact higher than a preset level, which further improves the ordering probability of the recommended products.

In some embodiments, the recommended user may also share his shopping information. The transmitter 203 may be further configured to transmit the shopping information of the recommended user to the contact, the shopping information of the recommended user being acquired by the processor 202. Therefore, after the recommended user sends the communication identifier of the contact to the information recommendation platform, the recommended user and the contact establish a relationship with each other as recommenders. The information recommendation platform can recommend the shopping information of any one in the relationship to the other one, thereby realizing information sharing.

In some embodiments, a user can set authorization of publication of his own shopping information. If the user sets the authorization of certain shopping information to be public, the transmitter 203 may transmit the shopping information to other users; otherwise, the transmitter 203 does not transmit the shopping information. For example, the user may send a request indicating whether certain shopping information is public. At this time, the processor 220 may be further configured to set the shopping information of the user public or private according to the request of the user. After the user has made the setting, he may re-send a request to change the setting.

In the recommendation process, the processor 202 may obtain the shopping information of the contact and information whether the shopping information is public according to the searched user identifier; then, the transmitter 203 may transmit the contact's public shopping information to the recommended user without transmitting the contact's private shopping information. Therefore, the privacy of the user can be protected, and the user experience is improved.

Embodiments of an information recommendation application module of the present disclosure are described below with reference to FIG. 3.

FIG. 3 shows an exemplary structural diagram of an information recommendation application module according to some embodiments of the present disclosure. As shown in FIG. 3, the information recommendation application module 30 of the embodiments comprises a processor 301, a transmitter 302, a receiver 303, and an output interface 304. These components may be implemented in hardware or software, and may be specific to the information recommendation application module 30 or shared with other apparatus in the device in which the information recommendation application module 30 is located.

The processor 301 may for example acquire the communication identifier of the contact of the recommended user from a communication application, e.g. the processor 301 may be a jump interface between different applications. In some embodiments, the communication application may be located at the terminal.

The communication application may be a call application, such as a phone dialing application or an address book application. In this case, the communication identifier may be, for example, a phone number, an email address, an application account, or the like. The communication application may also be an email application. In this case, the communication identifier may be, for example, an email address. The communication application can also be a social networking application, and the communication identifier can be an application account or the like, so that the shortage of the lack of social attributes of the e-commerce platform can be made up by a mature social system in the social networking application.

When the user uses the information recommendation application module 30, the user may indicate the application to perform contact-based recommendation by operations, or the information recommendation application module 30 may periodically initiate the recommendation function. At this time, the information recommendation application module 30 may, for example, call the processor 301 and send an instruction to read the contact.

In some embodiments, the communication application may set the read authorization of the information recommendation application module 30 in advance. Thus, the information recommendation application module 30 can read communication identifiers of the contacts in the communication application under the condition of authorization of the communication application. In some embodiments, the information recommendation application module 30 may read communication identifiers of some or all contacts in the communication application according to the selection of the user, or may perform acquisition in units of groups according to the grouping of the contacts.

In addition, the processor 301 may also acquire communication identifiers from a cloud system or a communication application server, which is not described herein again.

The transmitter 302 is configured to transmit the communication identifier to the information recommendation platform 20. Therefore, the information recommendation platform 20 may search for the user identifier corresponding to the communication identifier, obtain the shopping information of the contact according to the searched user identifier, and return the searched content to the information recommendation application module 30.

The receiver 303 is configured to receive the shopping information of the contact sent by the information recommendation platform. The receiver 303 may receive one or more types of shopping information sent by the information recommendation platform.

The receiver 303 may also receive information other than the shopping information sent by the information recommendation platform 20 as needed. For example, the receiver 303 may receive a contact information corresponding to the shopping information, the communication identifier of the contact, and the like when receiving the shopping information, so that the recommended user may know the shopping information is recommended based on which user's shopping condition.

The output interface 304 is configured to output the shopping information of the contact to the recommended user. The output interface 304 may be, for example, an interface of a display device or an interface of a playback device, so that shopping information may be delivered to the user via a screen or sound.

When the output interface 304 is an interface of a display device, the terminal 30 may display information of a product through an application page on a screen, or display a summary of the product through a notification message, or may also display a comment of a contact on a detail page of the product, or the like, for example.

In addition, the output interface 304 may also output part of or all the other information received by the receiver 303, or may also output information other than the information received by the receiver 303, such as the name of a contact, etc., as needed.

Through the above-described embodiments, the information recommendation device provided by the present disclosure can recommend shopping information for the recommended user according to the shopping condition of the contact of the recommended user. Therefore, the recommended content has higher credibility, so that the click rate and the order conversion rate of the user are improved, and the recommendation efficiency is improved.

The various components in the information recommendation device provided by the present disclosure may also have further configurations to implement other functions.

In some embodiments, after receiving the recommended content, the recommended user can conveniently contact with a contact corresponding to the recommended shopping information. The output interface 304 may be further configured to output the shopping information and the communication identifier of the corresponding contact to the recommended user. For example, when the output interface 304 displays shopping information of a contact, a contact name associated therewith, an identifier of the contact at an e-commerce platform or a communication identifier of the contact, etc. may be displayed at the same time. Thus, the recommended user may initiate a contact request for the displayed contact or the communication identifier of the contact.

At this time, the processor 301 may be further configured to, in response to an operation that the recommended user initiates communication to the contact, open a communication application and send the communication identifier of the contact to the communication application, so that the recommended user contacts with the contact through the communication application.

For example, the information recommendation application module 30 notes that product Z is recommended by contact C while displaying the product Z. The recommended user may click a button, text, or image identifying the contact C in order to ask the contact C about the use experience when the user has doubt about the comment of the product Z. At this time, a jump interface in the processor 301 of the information recommendation application module 30 transmits the phone number of the contact C to the dialing application and initiates the dialing application. The dialing application initiates communication to the phone number of the contact C in response to the above operation. Therefore, when receiving recommended product information, the user can conveniently contact with the contact related to the product information so as to further know the product, thus the use experience of the user is improved.

In some embodiments, the information recommendation application module 30 may recommend only the product information of which the contact's rating is higher than a preset level to the user. For example, the receiver 303 may be further configured to receive purchased item information of items purchased by the contact, which is sent by the information recommendation platform 20 and has an rating higher than a preset level. Accordingly, the output interface 304 also outputs only the information of the purchased items of which the rating is higher than a preset level to the user, thus the success rate of recommendation is further improved.

In some embodiments, the receiver 303 may be further configured to receive the contact's public shopping information sent by the information recommendation platform. Therefore, the recommended user will not see the shopping information which the contact does not choose to make public, which effectively protects the privacy of the user. The information recommendation application module 30 may further comprise an input interface 305 configured to receive a setting by the user as whether to make the shopping information public and send the setting to the information recommendation platform 20, so that the information recommendation platform 20 sets whether to make the shopping information public.

In some embodiments, the information recommendation application module 30 may display recommendation information acquired according to the shopping information of the contact, and recommendation information acquired through other methods in different manners. The output interface 304 may be further configured to display the shopping information of the contact and other recommendation information in different manners. The different display manners may be different display colors, different fonts, different layouts, different display positions or different display marks, and the like. For example, the shopping information of the contact may be highlighted, displayed on top, or specially marked and displayed to enable the user to know which shopping information comes from the contact, thereby facilitating the user to screen and select.

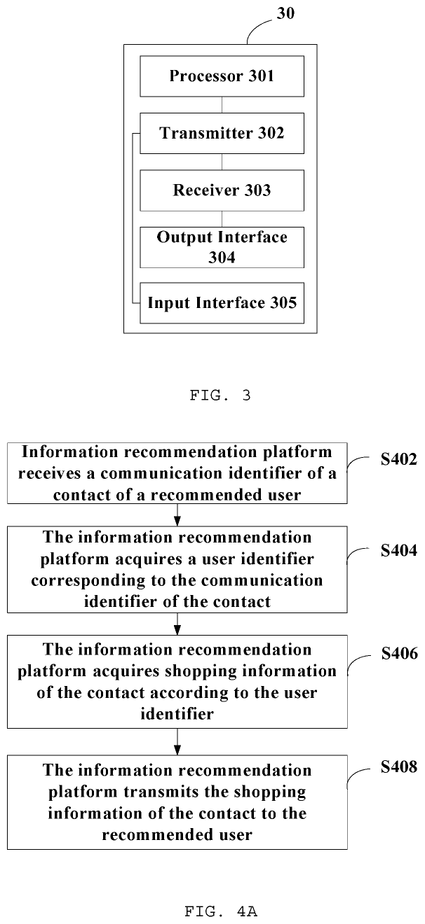

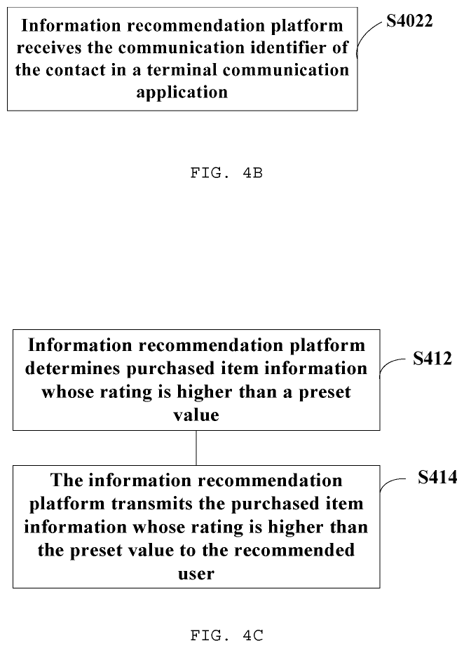

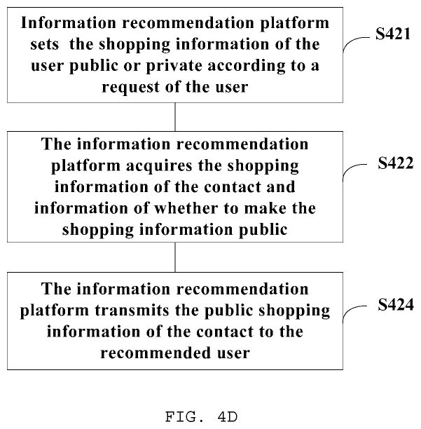

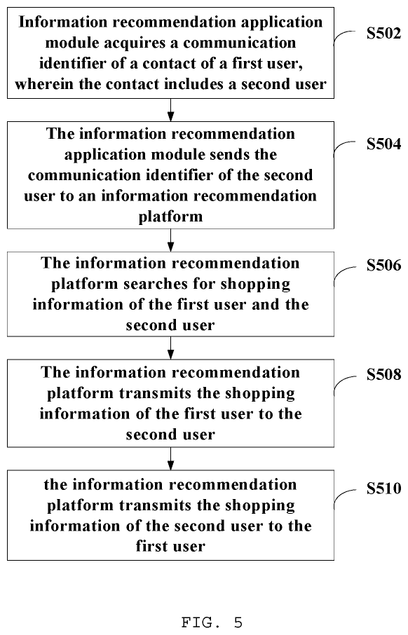

Embodiments of the information recommendation method of the present disclosure are described below with reference to FIGS. 4A to 4D.

FIG. 4A shows an exemplary flow diagram of an information recommendation method according to some embodiments of the present disclosure. As shown in FIG. 4A, the information recommendation method of the embodiments comprises steps S402 to S410.

In step S402, an information recommendation platform receives a communication identifier of a contact of a recommended user. The communication identifier of the contact can be sent by an information recommendation application module, or can be obtained from other devices or systems. One implementation of step S402 may refer to step S4022 in FIG. 4B. In step S4022, the information recommendation platform acquires the communication identifier of the contact in a terminal communication application. The communication application may be located in a terminal, or may be located in a cloud or a server, or the like. The communication application may be, for example, a call application, a social networking application, or an email application. The communication identifier may be, for example, a phone number, a social network account, an e-mail address, a personal home page link, or the like.

In step S404, the information recommendation platform acquires a user identifier corresponding to the communication identifier of the contact.

In step S406, the information recommendation platform acquires shopping information of the contact according to the user identifier. The shopping information comprises one or more of purchased item information, rating information, collection information, or browsing information. The information recommendation platform may, for example, look up information from a database.

In step S408, the information recommendation platform transmits the shopping information of the contact to the recommended user. In some embodiments, the shopping information of the contact may be sent to a terminal of the recommended user, for example, for displaying through a notification message of the terminal or an e-commerce application of the terminal, so as to facilitate viewing by the user.

Through the method of the above-described embodiments, the present disclosure can recommend shopping information for the recommended user according to the shopping condition of the contact of the recommended user, so that the recommended content has higher credibility, thus the click rate and the order conversion rate of the user are improved, and the recommendation efficiency is improved.

FIG. 4C shows an exemplary flow diagram of an information recommendation method according to further embodiments of the present disclosure. As shown in FIG. 4C, the information recommendation method of the embodiments comprises steps S412 to S414.

In step S412, the information recommendation platform acquires rating information corresponding to the purchased item information of the contact according to a searched user identifier, and determines the purchased item information whose rating is higher than a preset level.

In step S414, the information recommendation platform transmits the purchased item information whose rating is higher than the preset level to the recommended user, for example, the recommended user can be recommended by an information recommendation application module.

Thus, only items whose rating of the contact is better than expected can be recommended to the recommended user.

FIG. 4D shows an exemplary flow diagram of an information recommendation method according to still further embodiments of the present disclosure. As shown in FIG. 4D, the information recommendation method of this embodiment comprises steps S422 to S424.

In step S422, the information recommendation platform obtains the shopping information of the contact and information of whether the shopping information is made public according to a searched user identifier.

In step S424, the information recommendation platform transmits the public shopping information of the contact to the recommended user. For example, an information recommendation application module may receive the public shopping information of the contact sent by the information recommendation platform and transmit it to the recommended user.

In addition, whether or not the shopping information of the user is made public may be set according to a request of the user, as shown in step S421. In step S421, the information recommendation platform sets the shopping information of the user public or private according to the request of the user.

Through the method of the embodiments, the privacy of the user can be protected.

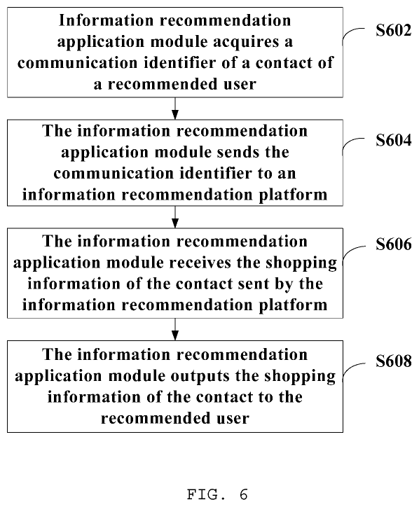

In addition, the user and the contact can establish a relationship with each other as recommenders. Embodiments of the information recommendation method of the present disclosure are described below with reference to FIG. 5.

FIG. 5 shows an exemplary flow diagram of an information recommendation method according to still further embodiments of the present disclosure. As shown in FIG. 5, the information recommendation method of the embodiments comprises steps S502 to S510.

In step S502, an information recommendation application module acquires one or more communication identifiers of contacts of a first user, where the contacts comprise a second user.

In step S504, the information recommendation application module sends communication identifier of the second user to an information recommendation platform.

In step S506, the information recommendation platform searches for shopping information of the first user and the second user.

In step S508, the information recommendation platform transmits the shopping information of the first user to the second user.

In step S510, the information recommendation platform transmits the shopping information of the second user to the first user.

Steps S508 and S510 may be executed simultaneously, step S508 may be executed first, or step S510 may be executed first.

Therefore, after the recommended user (i.e. the first user in the above embodiment) sends a communication identifier of a contact to the information recommendation platform, the recommended user and the contact (i.e. the second user in the above embodiment) establish a relationship with each other as recommenders. The information recommendation platform can recommend the shopping information of any one in the relationship to the other one, thereby realizing information sharing.

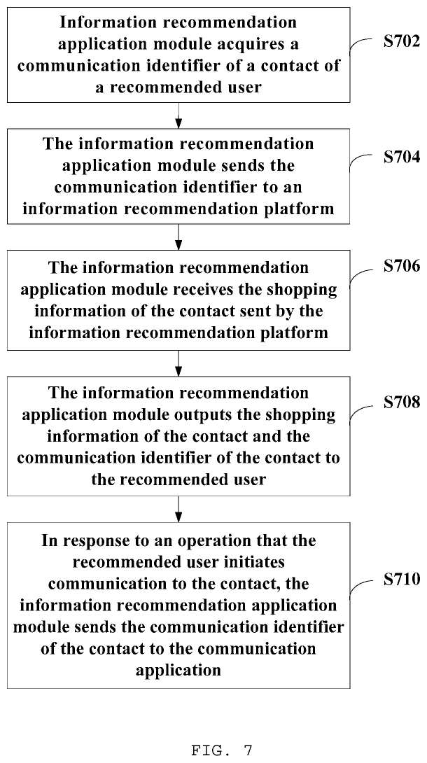

FIG. 6 shows an exemplary flow diagram of an information recommendation method according to still further embodiments of the present disclosure. As shown in FIG. 6, the information recommendation method of the embodiments comprises steps S602 to S608.

In step S602, an information recommendation application module acquires a communication identifier of a contact of a recommended user. The information recommendation application module can acquire the communication identifier of the contact of the recommended user from a communication application.

In step S604, the information recommendation application module sends the communication identifier to the information recommendation platform, so that the information recommendation platform searches for a user identifier corresponding to the communication identifier, and obtains shopping information of the contact according to the searched user identifier.

In step S606, the information recommendation application module receives the shopping information of the contact sent by the information recommendation platform. In some embodiments, the information recommendation application module may receive purchased item information of one or more items purchased by the contact, which is sent by the information recommendation platform and has an rating higher than a preset level. Thus, the information recommendation application module can transmit the purchased item information whose rating is higher than the preset level of the items purchased by the contact to the recommended user.

In some embodiments, the information recommendation application module may receive the contact's public shopping information sent by the information recommendation platform. Therefore, the recommended user cannot view shopping information that the contact chooses not to make public, which can protect the privacy of the user. The information recommendation application module may also receive a setting by the user of whether to make the shopping information public and send the setting to the information recommendation platform so that the information recommendation platform sets whether to make the shopping information public.

In step S608, the information recommendation application module outputs the shopping information of the contact to the recommended user. For example, the information recommendation application module may perform recommendation by displaying graphics and text or playing sound. For example, when a user browses a product, the information recommendation application module may display the evaluation content of the contact and the rating on the product on the top of the comment area, so that the user may get a viewpoint of the contact first.

In some embodiments, the shopping information of the contact may be displayed to the user, wherein the shopping information of the contact and other recommended information are displayed in different manners. Thus, the contact-based recommended shopping information can be specially labeled to be distinguished from other information.

Through the method of the embodiment, the present disclosure can recommend shopping information for the recommended user according to the shopping condition of the contact of the recommended user, so that the recommended content has higher credibility, thus the click rate and the order conversion rate of the user are improved, and the recommendation efficiency is improved.

FIG. 7 is an exemplary flow diagram of an information recommendation method according to still further embodiments of the present disclosure. As shown in FIG. 7, the information recommendation method of the embodiments comprises steps S702 to S710.

In step S702, an information recommendation application module acquires a communication identifier of a contact of a recommended user.

In step S704, the information recommendation application module sends the communication identifier to an information recommendation platform, so that the information recommendation platform searches for a user identifier corresponding to the communication identifier, and acquires shopping information of the contact according to the searched user identifier.

In step S706, the information recommendation application module receives the shopping information of the contact sent by the information recommendation platform.

In step S708, the information recommendation application module outputs the shopping information of the contact and the communication identifier of the contact to the recommended user.

In step S710, in response to an operation that the recommended user initiates communication to the contact, the information recommendation application module opens a communication application and sends the communication identifier of the contact to the communication application, so that the recommended user contacts with the contact through the communication application.

Through the method of the above embodiments, when receiving recommended product information, the user can conveniently contact with the contact related to the product information so as to further know the product, thus the use experience of the user is improved.

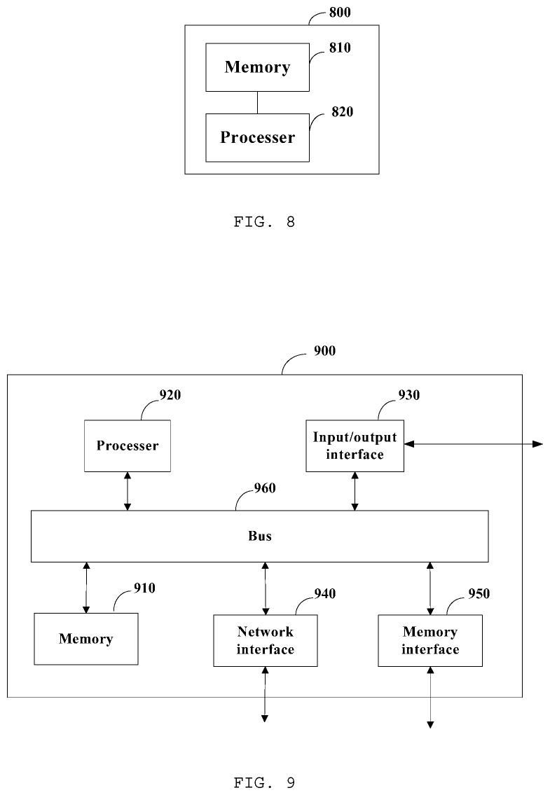

FIG. 8 shows an exemplary structural diagram of an information recommendation device of some embodiments of the present disclosure. As shown in FIG. 8, an information recommendation device 800 of the embodiments comprises: a memory 810 and a processor 820 coupled to the memory 810, the processor 820 being configured to perform the information recommendation method of any of the embodiments described above based on instructions stored in the memory 810.

Memory 810 may comprise, for example, a system memory, a fixed non-volatile storage medium, and the like. The system memory stores, for example, an operating system, an application program, a Boot Loader, and other programs.

FIG. 9 is an exemplary structural diagram of an information recommendation device according to further embodiments of the present disclosure. As shown in FIG. 9, an information recommendation device 900 of the embodiments comprises memory 910 and processor 920, and may also comprise input/output interface 930, network interface 940, storage interface 950, and so forth. These interfaces 930, 940, 950 and the memory 910 and the processor 920 may be connected by a bus 960, for example. The input/output interface 930 provides a connection interface for input/output devices such as a display, a mouse, a keyboard, and a touch screen. The network interface 940 provides a connection interface for various networking devices. The storage interface 950 provides a connection interface for an external storage device such as an SD card and a U disk.

The embodiments of the present disclosure also provide a computer-readable storage medium having stored thereon a computer program, wherein the program, when executed by a processor, implements any one of the foregoing information recommendation methods.

It shall be understood by those skilled in the art that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disks, CD-ROM, optical storage, etc.) having computer-usable program code embodied in the medium.

The present disclosure is described with reference to the flow diagrams and/or block diagrams of the method, device (system) and computer program product according to the embodiments of the present disclosure. It shall be understood that each flow and/or block in the flow diagrams and/or block diagrams and a combination thereof may be implemented by computer program instructions. These computer program instructions may be provided to the processor of a general purpose computer, a dedicated computer, an embedded processing device or any other programmable data processing device to produce a machine causing the instructions executed by the processor of the computer or the other programmable data processing device to produce means for implementing the functions designated in the one or more flows in the flow charts and/or one or more blocks in the block diagrams.

These computer program instructions may be stored in a computer readable memory that can direct a computer or any other programmable data processing device to operate in a specific manner, such that the instructions stored in the computer readable memory produce a manufactured article including instruction means that implements the functions designated in one or more flows in the flow charts and/or one or more blocks in the block diagrams.

These computer program instructions may also be loaded on a computer or any other programmable data processing device causing the computer or the other programmable data processing device to perform a series of operation steps to produce a computer-implemented process, such that the instructions executed on the computer or the other programmable device provide steps for implementing the functions designated in the one or more flows in the flow charts and/or one or more blocks in the block diagrams.

The above contents are only preferred embodiments of the present disclosure, but are not used to limit the present disclosure. Any modification, equivalent replacement, improvement and etc. within spirit and principles of the present disclosure shall be contained in the protection scope of the present disclosure.

1. An information recommendation device in an information recommendation platform, comprising:
a receiver configured to receive a communication identifier of a contact of a recommended user;
a processor configured to acquire a user identifier corresponding to the communication identifier of the contact, and acquire shopping information of the contact according to the user identifier; and
a transmitter configured to transmit the shopping information of the contact to a terminal of the recommended user to recommend one or more items.

2. The information recommendation device of claim 1, wherein the receiver is further configured to receive the communication identifier of the contact of the recommended user acquired by the terminal from a communication application or by a cloud or by a server.

3. The information recommendation device of claim 1, wherein the transmitter is further configured to transmit at least one of the following information to the recommended user:
purchased item information with a rating higher than a preset level in the shopping information of the contact; or
public shopping information of the contact.

4. The information recommendation device of claim 1, wherein the shopping information comprises one or more of purchased item information, rating information, collection information, or browsing information.

5. The information recommendation device of claim 1, wherein the processor is further configured to set the shopping information of the contact public or private according to a request of the contact.

6. The information recommendation device of claim 1, wherein
the processor is further configured to acquire shopping information of the recommended user;
the transmitter is further configured to transmit the shopping information of the recommended user to the contact.

7. An information recommendation device in a terminal, comprising:
a processor configured to acquire a communication identifier of a contact of a recommended user;
a transmitter configured to transmit the communication identifier to an information recommendation platform;
a receiver configured to receive shopping information of the contact from the information recommendation platform, wherein the shopping information of the contact is acquired via a user identifier of the contact corresponding to the communication identifier; and
an output interface configured to output the shopping information of the contact to the recommended user to recommend one or more items.

8. The information recommendation device of claim 7, wherein the output interface is further configured to output the shopping information of the contact and the communication identifier of the contact to the recommended user;
the processor is further configured to, in response to an operation that the recommended user initiates communication to the contact, send the communication identifier of the contact to a communication application, so that the recommended user contacts with the contact through the communication application.

9. The information recommendation device of claim 7, wherein the output interface is further configured to display the shopping information of the contact and other recommendation information in different manners.

10. An information recommendation method performed in an information recommendation platform, comprising:
receiving a communication identifier of a contact of a recommended user;
acquiring a user identifier corresponding to the communication identifier of the contact;
acquiring shopping information of the contact according to the user identifier; and
transmitting the shopping information of the contact to a terminal of the recommended user to recommend one or more items.

11. The information recommendation method of claim 10, wherein the communication identifier of the contact of the recommended user acquired by the terminal from a communication application or by a cloud or by a server is received.

12. The information recommendation method of claim 10, wherein at least one of the following information is transmitted to the recommended user:
purchased item information with a rating higher than a preset level in the shopping information of the contact; or
public shopping information of the contact.

13. The information recommendation method of claim 10, further comprising:
setting the shopping information of the contact public or private according to a request of the contact.

14. The information recommendation method of claim 10, further comprising:
acquiring the shopping information of the recommended user;
transmitting the shopping information of the recommended user to the contact.

15-17. (canceled)

18. An information recommendation device, comprising:
a memory; and
a processor coupled to the memory, which is configured to execute the information recommendation method according to claim 10 on a basis of instructions stored in the memory.

19. A non-transitory computer readable storage medium having stored thereon a computer program which, when executed by a processor, implements the information recommendation method of claim 10.

20. The information recommendation device of claim 18, wherein the communication identifier of the contact of the recommended user acquired by the terminal from a communication application or by a cloud or by a server is received.

21. The information recommendation device of claim 18, wherein at least one of the following information is transmitted to the recommended user:
purchased item information with a rating higher than a preset level in the shopping information of the contact; or
public shopping information of the contact.

22. The information recommendation device of claim 18, wherein the instructions further comprise:
setting the shopping information of the contact public or private according to a request of the contact.

23. The information recommendation device of claim 18, wherein the instructions further comprise:
acquiring the shopping information of the recommended user;
transmitting the shopping information of the recommended user to the contact.
